(19) United States
(12) Patent Application Publication
(10) Pub. No.: US 2023/0093844 A1
(43) Pub. Date: Mar. 30, 2023

(54) RIG ACTIVITY MANAGEMENT

(71) Applicant: Nabors Drilling Technologies USA, Inc., Houston, TX (US)

(72) Inventor: Scott BOONE, Houston, TX (US)

(21) Appl. No.: 17/934,241

(22) Filed: Sep. 22, 2022

Related U.S. Application Data
(60) Provisional application No. 63/261,814, filed on Sep. 29, 2021.

(51) Int. Cl. G06Q 10/06

(52) U.S. Cl. CPC G06Q 10/0635; G06Q 10/06398; G06Q 50/06

(57) ABSTRACT

A method for analyzing an environment that can include conducting a subterranean operation within an environment, obtaining sensor data from one or more sensors configured to monitor the environment, identifying an actual well activity within the environment based on the sensor data, identifying an individual within the environment based on the sensor data, and calculating an adherence score for the actual well activity based at least in part on an adherence score of the individual performing a task in the environment.

### CROSS-REFERENCE TO RELATED APPLICATION(S)

This application claims priority under 35 U.S.C. § 119(e) to U.S. Provisional Application No. 63/261,814, entitled “RIG ACTIVITY MANAGEMENT,” by Scott BOONE, filed Sep. 29, 2021, which is assigned to the current assignee hereof and incorporated herein by reference in its entirety.

### TECHNICAL FIELD

The present invention relates, in general, to the field of drilling and processing of wells. More particularly, present embodiments relate to a system and method for analyzing and scoring adherence of rig equipment and personnel to perform activities according to a well plan or rig plan.

### BACKGROUND

During well construction operations, activities on a rig can be organized according to a well plan. The well plan can be converted to a rig plan (i.e., rig specific well construction plan) for implementation on a specific rig. Deviations from the well plan or rig plan can cause rig delays, increase well site operation costs, and cause other impacts to operations. Poorly performed well plan activities or rig plan tasks on the rig can cause delays or even unplanned activities or tasks if the activity or task is in a high priority path. Delays in identifying the poor performance can exacerbate these impacts. Therefore, improvements in rig activity monitoring and reporting are continually needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by the data processing apparatus, cause the apparatus to perform the actions. One general aspect includes a method for analyzing an environment. The method also includes conducting a subterranean operation within an environment; obtaining sensor data from one or more sensors configured to monitor the environment, identifying an actual well activity within the environment based on the sensor data, identifying an individual within the environment based on the sensor data, and calculating an adherence score for the actual well activity based at least in part on an adherence score of the individual performing a task in the environment. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1A is a representative simplified front view of a rig being utilized for a subterranean operation, in accordance with certain embodiments;

FIG. 1B is a representative simplified view of a user using possible wearable devices for user input or identification, in accordance with certain embodiments;

FIG. 2 is a representative partial cross-sectional view of a rig being utilized for a subterranean operation, in accordance with certain embodiments;

FIG. 3A is a representative front view of various users detected via imaging system, in accordance with certain embodiments;

FIG. 3B is a representative block diagram of a method 200 for detecting an individual and determining an adherence score for the individual, in accordance with certain embodiments;

FIG. 4 is a representative flow diagram of a method for calculating an adherence score for a well activity, in accordance with certain embodiments;

FIG. 5 is a representative block diagram of an environment with multiple zones at a rig site, in accordance with certain embodiments;

FIG. 6 is a representative functional block diagram of a method using a computer to determine adherence scores for various individuals and activities, in accordance with certain embodiments;

FIG. 7 is a representative flow diagram of a method for determining an actual well activity state of a rig, in accordance with certain embodiments;

FIG. 8A is a representative list of well activities for an example digital well plan, in accordance with certain embodiments;

FIG. 8B is a representative functional diagram that illustrates conversion of well plan activities to rig plan tasks, in accordance with certain embodiments; and

FIG. 9 is a representative functional diagram that illustrates possible databases used by a rig controller to convert a digital well plan to a digital rig plan, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

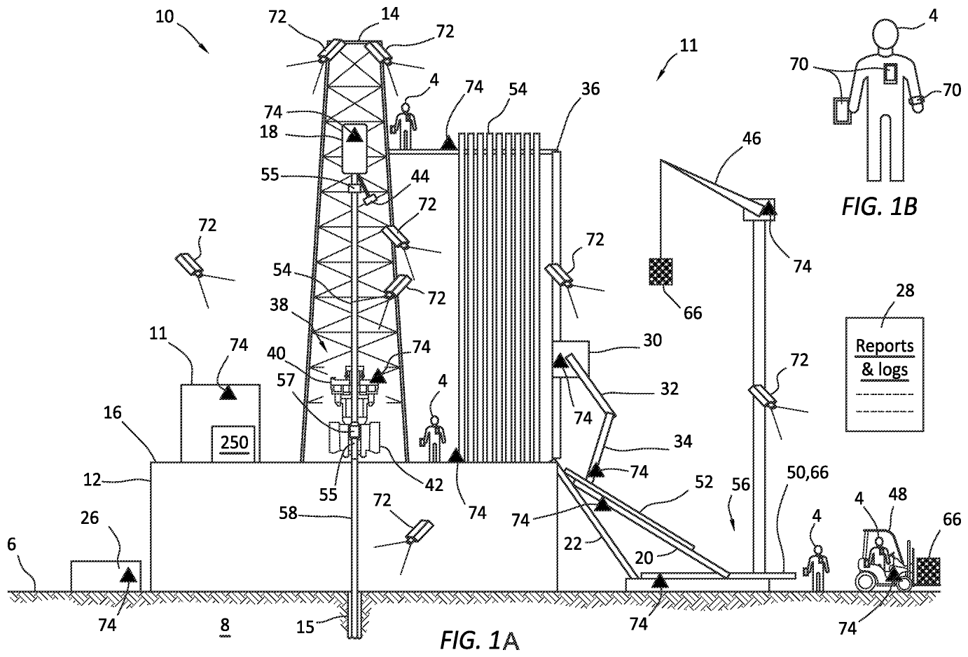

As used herein, “tubular” refers to an elongated cylindrical tube and can include any of the tubulars manipulated around a rig, such as tubular segments, tubular stands, tubulars, and tubular string, but not limited to the tubulars shown in FIG. 1A. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

FIG. 1A is a representative simplified front view of a rig 10 at a rig site 11 being utilized for a subterranean operation (e.g., tripping in or out a tubular string to or from a wellbore), in accordance with certain embodiments. The rig site 11 can include the rig 10 with its rig equipment, along with equipment and work areas that support the rig 10 but are not necessarily on the rig 10. The rig 10 can include a platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the fingerboard 36, the wellbore 15, etc. However, it is not required that a pipe handler 30 be used on the rig 10. The top drive 18 can transfer tubulars directly to and directly from the catwalk 20 (e.g., using an elevator coupled to the top drive).

The tubular string 58 can extend into the wellbore 15, with the wellbore 15 extending through the surface 6 into the subterranean formation 8. When tripping the tubular string 58 into the wellbore 15, tubulars 54 are sequentially added to the tubular string 58 to extend the length of the tubular string 58 into the earthen formation 8. FIG. 1A shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 are sequentially removed from the tubular string 58 to reduce the length of the tubular string 58 in the wellbore 15. The pipe handler 30 can be used to remove the tubulars 54 from an iron roughneck 38 or a top drive 18 at a well center 24 and transfer the tubulars 54 to the catwalk 20, the fingerboard 36, etc. The iron roughneck 38 can break a threaded connection between a tubular 54 being removed and the tubular string 58. A spinner assembly 40 (or pipe handler 30) can engage a body of the tubular 54 to spin a pin end 57 of the tubular 54 out of a threaded box end 55 of the tubular string 58, thereby unthreading the tubular 54 from the tubular string 58.

When tripping the tubular string 58 into the wellbore 15, tubulars 54 are sequentially added to the tubular string 58 to increase the length of the tubular string 58 in the wellbore 15. The pipe handler 30 can be used to deliver the tubulars 54 to a well center on the rig floor 16 in a vertical orientation and hand the tubulars 54 off to an iron roughneck 38 or a top drive 18. The iron roughneck 38 can make a threaded connection between the tubular 54 being added and the tubular string 58. A spinner assembly 40 or pipe handler 30 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection.

While tripping a tubular string into or out of the wellbore 15 can be a significant part of the operations performed by the rig, many other rig tasks are also needed to perform a well construction according to a digital well plan. For example, pumping mud at desired rates, maintaining downhole pressures (as in managed pressure drilling), maintaining, and controlling rig power systems, coordinating, and managing personnel on the rig during operations, performing pressure tests on sections of the wellbore 15, cementing a casing string in the wellbore, performing well logging operations, as well as many other rig tasks.

A rig controller 250 can be used to control the rig 10 operations including controlling various rig equipment, such as the pipe handler 30, the top drive 18, the iron roughneck 38, the fingerboard equipment, imaging systems, various other robots on the rig 10 (e.g., a drill floor robot), or rig power systems 26. The rig controller 250 can control the rig equipment autonomously (e.g., without periodic operator interaction,), semi-autonomously (e.g., with limited operator interaction such as initiating a subterranean operation, adjusting parameters during the operation, etc.), or manually (e.g., with the operator interactively controlling the rig equipment via remote control interfaces to perform the subterranean operation). A score can be determined (e.g., by the controller 250) for personnel or rig equipment used in performing the subterranean operation to indicate an adherence of the personnel or rig equipment to perform the subterranean operation according to the well plan or rig plan. The scores for individuals can indicate proficiency of the individual to perform the needed tasks for the subterranean operation, or if the individual is performing the needed tasks on time and in the right location, or can indicate a need for additional skills training for the individual. The scores for the rig equipment can indicate that the equipment is operating correctly or that the equipment may need maintenance or repair.

The rig controller 250 can include one or more processors with one or more of the processors distributed about the rig 10, such as in an operator's control hut 11, in the pipe handler 30, in the iron roughneck 38, in the fingerboard 36, in the imaging systems, in various other robots, in the top drive 18, at various locations on the rig floor 16 or the derrick 14 or the platform 12, at a remote location off of the rig 10, at downhole locations, etc. It should be understood that any of these processors can perform control or calculations locally or can communicate to a remotely located processor for performing the control or calculations. Each of the processors can be communicatively coupled to a non-transitory memory, which can include instructions for the respective processor to read and execute to implement the desired control functions or other methods described in this disclosure. These processors can be coupled via a wired or wireless network. All data received and sent by the rig controller 250 is in a computer-readable format and can be stored in and retrieved from the non-transitory memory.

The rig controller 250 can collect data from various data sources around the rig (e.g., sensors, user input, local rig reports, etc.) and from remote data sources (e.g., suppliers, manufacturers, transporters, company men, remote rig reports, etc.) to monitor and facilitate the execution of a digital well plan. A digital well plan is generally designed to be independent of a specific rig, where a digital rig plan is a digital well plan that has been modified to incorporate the specific equipment available on a specific rig to execute the well plan on the specific rig, such as rig 10. Therefore, the rig controller 250 can be configured to monitor and facilitate the execution of the digital well plan by monitoring and executing rig tasks in the digital rig plan.

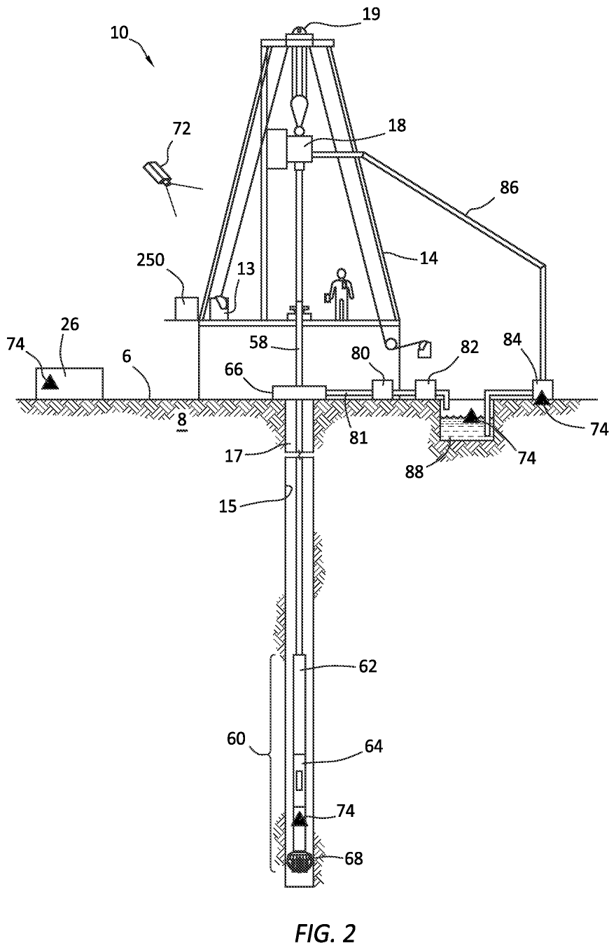

Examples of local data sources are shown in FIG. 1A where an imaging system can include the rig controller 250 and imaging sensors 72 positioned at desired locations around the rig and around the support equipment/material areas, such as mud pumps (see FIG. 2), horizontal storage area 56, power system 26, etc. to collect imagery of the desired locations. Also, various sensors 74 can be positioned at various locations around the rig 10 and the support equipment/material areas to collect information from the rig equipment (e.g., pipe handler 30, roughneck 38, top drive 18, fingerboard 36, etc.) and support equipment (e.g., crane 46, forklift 48, horizontal storage area 56, power system 26, etc.) to collect operational parameters of the equipment. Additional information can be collected from other data sources, such as reports and logs 28 (e.g., tour reports, daily progress reports, reports from remote locations, shipment logs, delivery logs, personnel logs, etc.).

These data sources can be aggregated by the rig controller 250 and used to determine an estimated well activity of the rig and comparing it to the digital well plan to determine the progress and performance of the rig 10 in executing the digital well plan. The data collected from the data sources during a first time interval can be compared to reference data in a well activity database to determine the estimated well activity of the rig along with a confidence level that can indicate a level of confidence that the estimated well activity is the actual well activity being performed by the rig. A low confidence level may indicate that there is a low probability that the estimated well activity is the actual well activity being performed by the rig, and a high confidence level may indicate that there is a high probability that the estimated well activity is the actual well activity being performed by the rig. With the confidence level determined and the estimated well activity determined, the rig controller 250 can compare the estimated well activity to the expected well activity (which can be defined by the digital well plan) and determine if the estimated well activity is the actual well activity being performed on the rig 10.

If the confidence level is below a predetermined threshold, then data can be collected from the data sources during a second time interval and compared to reference data in a well activity database to confirm that the estimated well activity of the rig is the actual well activity being performed by the rig. The second time interval can be adjusted, based on the confidence level, to capture more or fewer data from the data sources. For example, if the confidence level is below a second predetermined threshold, then the second time interval can be increased to capture a larger amount of data from the data sources, but if the confidence level is above the second predetermined threshold, then the second time interval can be decreased to capture a smaller amount of data from the data sources. In either case, the second time interval can be adjusted as needed to confirm that the estimated well activity is the actual well activity being performed on the rig 10.

The data sources can also include wearables 70 (e.g., a smart wristwatch, a smartphone, a tablet, a laptop, an identification badge, a wearable transmitter, etc.) that can be worn by an individual 4 (or user 4) to identify the individual 4, deliver instructions to the individual 4, or receive inputs from the individual 4 via the wearable 70 to the rig controller 250 (see FIG. 1B). Network connections (wired or wireless) to the wearables 70 can be used for communication between the rig controller 250 and the wearables 70 for information transfer.

FIG. 2 is a representative partial cross-sectional view of a rig 10 being used to drill a wellbore 15 in an earthen formation 8. FIG. 2 shows a land-based rig, but the principles of this disclosure can equally apply to off-shore rigs, as well. The rig 10 can include a top drive 18 with a traveling block 19 used to raise or lower the top drive 18. A derrick 14 extending from the rig floor, can provide the structural support of the rig equipment for performing subterranean operations (e.g., drilling, treating, completing, producing, testing, etc.). The rig can be used to extend a wellbore 15 through the earthen formation 8 by using a drill string 58 having a Bottom Hole Assembly (BHA) 60 at its lower end. The BHA 60 can include a drill bit 68 and multiple drill collars 62, with one or more of the drill collars including instrumentation 64 for LWD and MWD operations. During drilling operations, drilling mud can be pumped from the surface 6 into the drill string 58 (e.g., via pumps 84 supplying mud to the top drive 18) to cool and lubricate the drill bit 68 and to transport cuttings to the surface via an annulus 17 between the drill string 58 and the wellbore 15.

The returned mud can be directed to the mud pit 88 through the flow line 81 and the shaker 80. A fluid treatment 82 can inject additives as desired to the mud to condition the mud appropriately for the current well activities and possibly future well activities as the mud is being pumped to the mud pit 88. The pump 84 can pull mud from the mud pit 88 and drive it to the top drive 18 to continue circulation of the mud through the drill string 58.

Sensors 74 and imaging sensors 72 can be distributed about the rig and downhole to provide information on the environments in these areas as well as operating conditions, health of equipment, well activity of equipment, fluid properties, WOB, ROP, RPM of the drill string, RPM of the drill bit 68, etc.

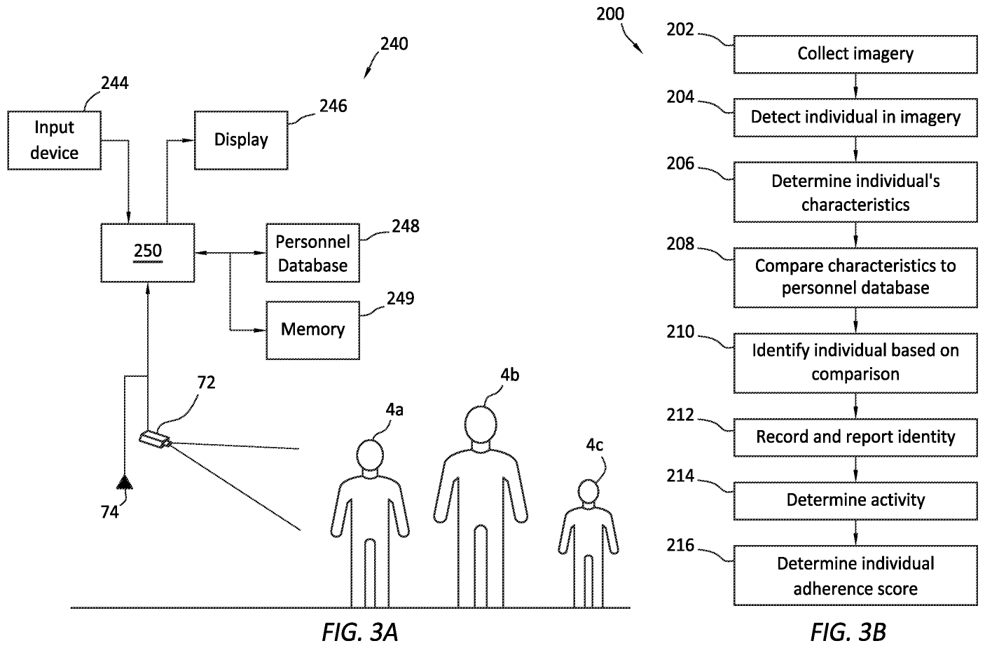

FIG. 3A is a representative front view of various individuals 4 (e.g., individuals 4a, 4b, 4c) that can be detectable via an imaging system 240. The imaging system 240 can include the rig controller 250, one or more imaging sensors 72, and one or more other sensors 74 (e.g., acoustic sensors, radio frequency identification RFID sensors, etc.), which can be positioned away from (or remote from) the individual 4. Some of the sensors can be one or more electronic devices with wireless communication capabilities, which are worn or carried by the individual 4. When determining the current well activity, it can be beneficial to detect how many individuals 4 are present on the rig 10, where they are, who they are, and what they are doing. For example, the imaging system 240 can be used to detect individuals 4 on the rig 10, track their location as they move about the rig 10, determine an identity of each of the individuals 4, determine the time each individual takes to perform a task, and score the individuals 4 on their adherence to the digital well plan 100.

By receiving imagery from the one or more imaging sensors 72, or sensor data from other sensors 74, the rig controller 250 can analyze the sensor data to detect characteristics of the individuals (such as individuals 4a, 4b, 4c) captured by imagery from the imaging sensor(s) or detected by the sensors 74 (e.g., acoustic sensors, RFID sensors, etc.). The rig controller 250 can compare the detected characteristics of each individual 4 (such as individuals 4a, 4b, 4c) with characteristics of individuals stored in the personnel database 248. The characteristics can include a detectable identification number (e.g., RFID device, bar code, QR code, etc.) physical characteristics, mannerisms, walking stride (or motion), body movements, silhouette, size, posture, body movements, facial features, or audible signals (e.g., via acoustic sensors 74). If the individual 4 is not included in the characteristics of individuals stored in the personnel database 248, the rig controller 250 can store the new individual in the personnel database 248 for future identification processes.

The rig controller 250 can detect (or sense) an individual on the rig by using one or more sensors 72, 74 that are remotely positioned relative to the individual. The one or more sensors 72, 74 can communicate directly or indirectly (e.g., via the rig controller 250) to a wearable electronic device 70 disposed on the individual 4. The rig controller 250 can analyze an exchange of information between the one or more sensors 72, 74 and the wearable electronic device 70 to confirm the identity of the individual 4. The exchange of information can include the detected characteristics of the individual 4. The individual 4 can also respond, via the wearable electronic device 70, to an inquiry from the rig controller 250 to the wearable electronic device 70 requesting confirmation of the individual's 4 identity. For example, a human machine interface provided by the wearable electronic device 70 such as a touch screen, can be used to receive input from the individual 4 to respond to the inquiry.

The rig controller 250 can detect (or sense) an individual in separate environments (e.g., red zone, drill floor, operator's hut 11, fingerboard 36, etc.) on the rig by using the one or more sensors 72, 74. The rig controller 250 can also determine an adherence score for each of one or more individuals 4 that is associated with one of more of the environments on the rig 10. Some environments on the rig 10 can be referred to as “safe zones,” “red zones,” and “no-go zones.” As used herein, a “safe zone” is an environment or area on the rig 10 that is designated as being safe for individuals 4 during rig operations. As used herein, a “red zone” is an environment or area on the rig 10 that is designated hazardous to individuals 4 during rig operations, but the individuals 4 are allowed to enter the red zone to perform necessary tasks. As used herein, a “no-go zone” is an environment or area on the rig 10 that is designated unsafe for individuals 4 during rig operations and individuals 4 should be prevented from entering no-go zones.

Based on the comparison of the detected characteristics to the stored characteristics, the rig controller 250 can determine the identity of each individual 4. The rig controller 250 can compare the tasks being performed by each identified individual 4, determine a length of time the individual took to perform the task, compare the task and the duration of the task with the digital well plan 100, and determine an adherence score for the individual 4. One or more individual 4 adherence scores and rig equipment adherence scores can be used to calculate (via the rig controller 250) an overall activity score for the well activity of the digital well plan 100 (or digital rig plan 102).

The rig controller 250 can also determine a location on the rig 10 of each individual 4 based on identification of the surroundings around the individuals in captured imagery or based on other sensor data. The rig controller 250 can record, report, or display the individual's 4 identity, location on the rig, adherence scores for well activities, and overall well activity adherence scores for the performance of the rig to the digital well plan 100.

FIG. 3B is a representative block diagram of a method 200 for detecting an individual and determining an adherence score for the individual. The method 200 illustrates a representative flow diagram for using the rig controller 250 to determine an identity of an individual 4 at the rig site using imagery from the imaging system 240. At operation 202, the rig controller 250 can autonomously (or as a result of a user request) collect imagery (or other sensor data from sensors 74) of one or more individuals 4 at the rig site via the imaging sensor(s) 72. At operation 204, the rig controller 250 can detect the one or more individuals in the imagery or sensor data. In operation 206, the rig controller 250 can analyze the imagery or sensor data to determine the characteristics of the individual 4. In operation 208, the rig controller 250 can compare the determined characteristics to characteristics in a personnel database 248. In operation 210, rig controller 250 can identify the individual 4 based on the comparison of the characteristics. In operation 212, rig controller 250 can record the individual's identity and report the identity to interested users. With the identity of each of the individuals determined, the rig controller 250 can compare the actual individuals with the well plan and can use the comparison to improve the confidence level of the estimated well activity.

After determining the unique identity of each individual 4, the rig controller 250 can determine the expertise/skills and experience level of the individual such as from a lookup table stored in non-transitory memory 249 which can be communicatively coupled to the rig controller 250. By knowing the unique identity of the individual, their skill set, and their location on the rig or in support areas, the rig controller 250 can assimilate this information along with the data from other various data sources to better determine the estimated well activity. If the estimated well activity is an expected well activity when compared to the digital well plan, then expected progress is being made in executing the digital well plan.

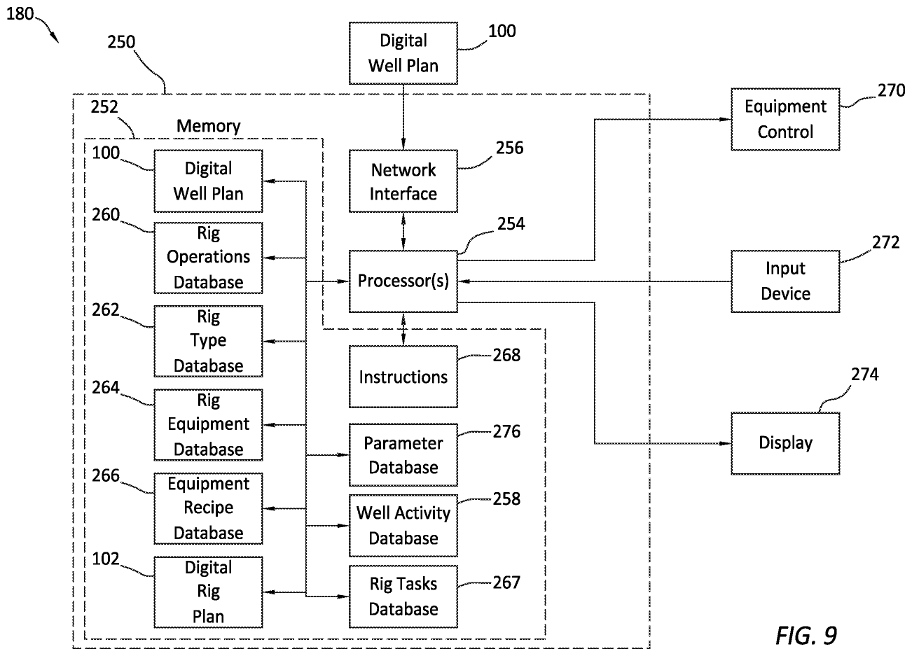

In operation 214, the rig controller 250 can determine an activity that each one of the individuals 4 is executing or if the individual is idle (such as waiting to begin a task). By monitoring each individual 4 (via imaging system 240 or other sensors 74), the rig controller 250 can determine how well each individual performed the task or activity they were executing. In operation 216, by comparing the performance of each individual 4 with an expected performance (which can be stored in the well activity database 258, see FIG. 9), the rig controller 250 can determine an adherence score for each individual 4. The adherence score for the individuals can be combined with adherence scores for rig equipment to determine an overall activity adherence score for the rig 10 for performing the digital well plan 100.

The rig controller 250, can use the imaging system 240 or other sensors 74 to collect operational information on the rig equipment of the rig 10 and compare the operation of each piece of rig equipment to an expected operation of each piece of the rig equipment (which can be stored in the well activity database 258, see FIG. 9). The rig controller 250 can then determine an adherence score for each piece of rig equipment being used to perform the digital well plan 100. The rig equipment adherence scores can be combined with the individual 4 adherence scores to determine an overall activity adherence score for the rig 10 for performing the digital well plan 100.

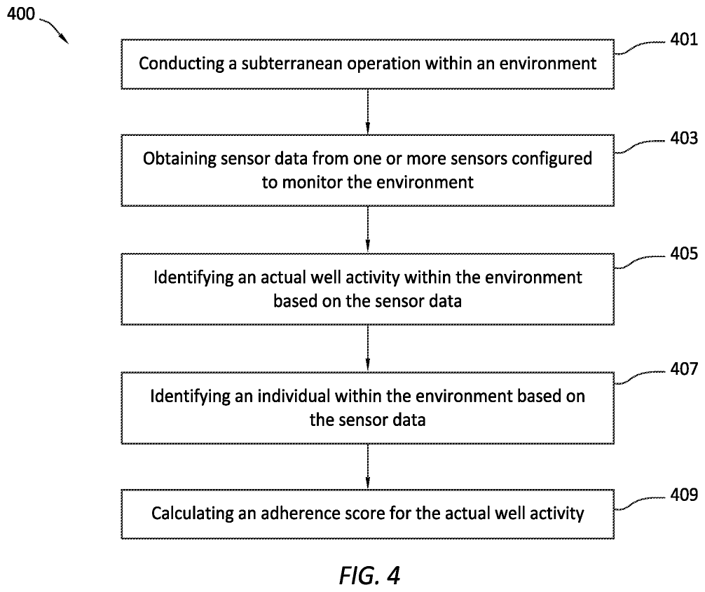

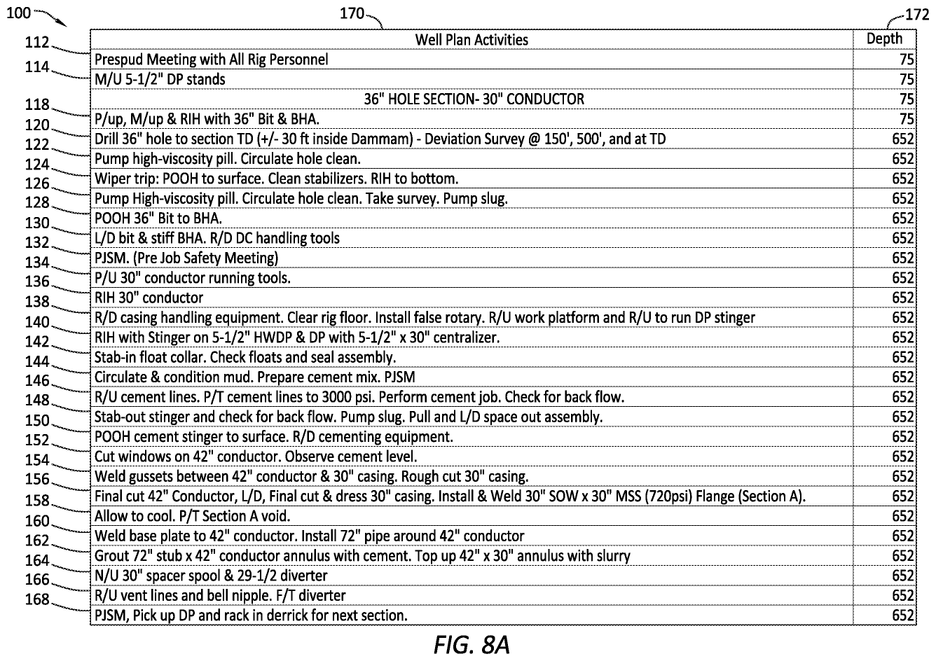

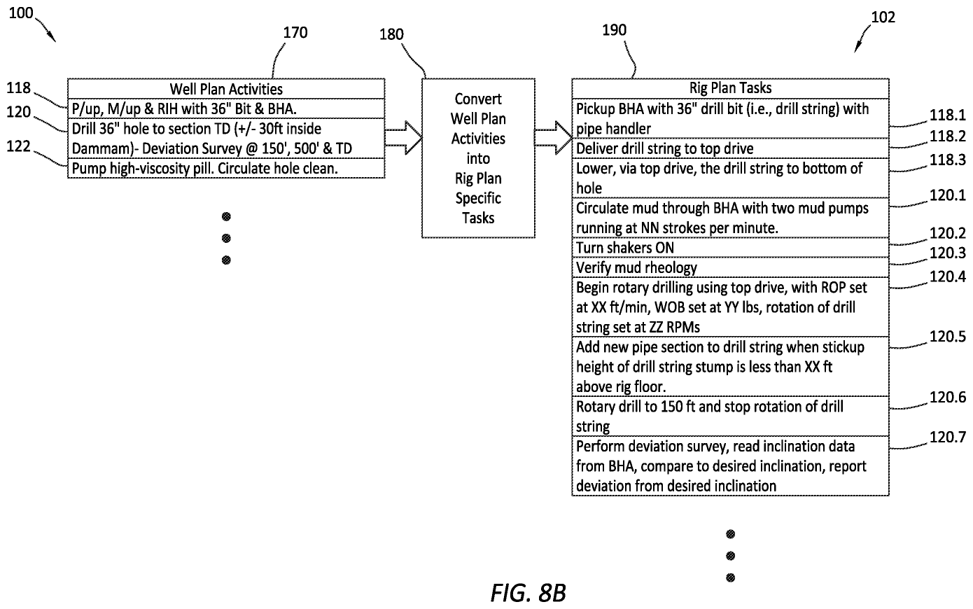

FIG. 4 is a representative flow diagram of a method 400 for calculating an adherence score for an actual well activity. Example well plan activities 170 are shown in FIGS. 8A and 8B. The method 400 can determine which of the well plan activities 170 of an actual digital well plan 100 is the actual well activity being performed on the rig 10 and determine an overall adherence score for the actual well activity to indicate the adherence of the actual well activity to the digital well plan activities 170.

In operation 401, the rig 10, along with rig personnel (e.g., individuals 4), is conducting a subterranean operation within an environment, with the environment including at least a portion of the rig 10. In operations 403, the sensors 72, 74 (e.g., imaging sensor, acoustic sensor, proximity sensor, thermal sensor, vibration sensor, RFID sensors, etc.) can be used to monitor rig tasks 190 being performed in the environment to execute the digital well plan 100 (or digital rig plan 102). The sensor(s) 72, 74 can provide sensor data (e.g., imagery, acoustic data, proximity sensor data, thermal sensor data, vibration sensor data, RFID data, etc.) to the rig controller 250, which can, in operation 405, use the sensor data to identify an actual well activity being performed in the environment. In operation 405, the rig controller 250 can compare the sensor data with expected sensor data that can be stored in the well activity database 258 (see FIG. 9). The well activity database 258 can include historical data from previously performed well activities 170 (or rig tasks 190). The historical data can provide performance expectations for the rig equipment and the individuals 4, as well as expected sensor data for previously executed well activities 170. The rig controller 250 can also, in operation 407, use the sensor data to identify one or more individuals working within the environment to perform tasks related to the actual well activity. In operation 409, the rig controller 250 can use the sensor data to determine an adherence score for the rig equipment being used in the actual well activity as well as an adherence score for the individual(s) performing tasks in the environment in support of the actual well activity.

From the adherence scores, the rig controller 250 can determine an overall adherence score for the actual well activity to indicate the performance of the actual well activity compared to an expected performance stored in the well activity database 258. For example, if the actual well activity utilized more, fewer, or the expected number of resources to complete the activity, the rig controller 250 can assign a respective reduced, higher, or acceptable adherence score to the actual well activity. Consequently, if the individual(s) take longer than expected to perform a rig task, require more individuals 4 to perform the rig task, or fail to perform the rig task, the rig controller 250 can assign a lower overall adherence score to the actual well activity to indicate a level of improvement that may be needed to perform the actual well activity in the future on rig 10 with the individuals 4. If the individual(s) 4 take less time than expected to do a rig task or require fewer individuals to perform the rig task, the rig controller 250 can assign a higher overall adherence score to the actual well activity to indicate that the actual well activity can be more efficient than expected.

The adherence scores for the rig equipment can be used to indicate that future maintenance activities may be needed, that the equipment is performing as good or better than expected, or that the equipment has failed and needs to be repaired or replaced. The adherence scores of the individuals can be used to indicate if one or more of the individuals 4 need additional training, are masters of the tasks performed, are working with outdated tools, or other performance metrics. The adherence scores can be monitored over time to determine a risk score for each individual 4, which can be used to indicate a probability that the individual 4 will perform the tasks adequately in the future.

Calculating the risk score can also include weighting factors, such as an individual's experience, a proficiency score, familiarity with the rig equipment, familiarity with the rig procedure, familiarity with the activity, environmental conditions, actual or perceived injuries, hours active, or combinations thereof. Therefore, a high risk score can indicate that the individual 4 may take longer to perform the task(s) than expected, may damage equipment when performing the task(s), or even fail to perform the task(s) in the future. A low risk score can indicate that the individual 4 may perform the task(s) quicker than expected, perform the task(s) with discipline and efficiency, or be helpful to improve the efficiency of others.

The risk score can be stored in a database for later retrieval by the rig controller 250 when calculating adherence scores. The risk scores for a group of individuals can be used to determine an overall risk score for the group (e.g., group of 3rd party contractors, group of individuals working 1st, 2nd, or 3rd shifts, group of new hires fresh out of training, etc.). The group risk score can be adjusted over time as the risk scores for each of the individuals 4 that make up the group are monitored and adjusted.

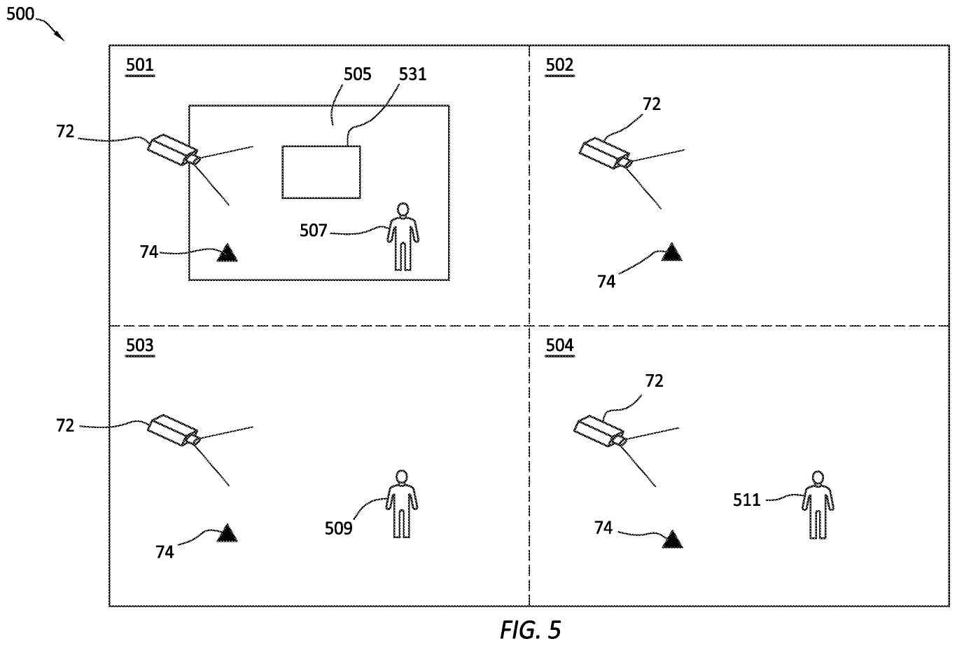

FIG. 5 is a representative block diagram of an environment 500 with multiple regions 501, 502, 503, 504 at a rig site 11. These regions can be different shapes as needed to organize access of individuals 4 to the regions 501, 502, 503, 504. Each region 501, 502, 503, 504 can include one or more imaging sensors 72 and one or more sensors 74. These sensors 72, 74 can capture sensor data (e.g., image data, acoustic data, proximity sensor data, thermal sensor data, vibration sensor data, RFID data, etc.) and communicate the sensor data to the rig controller 250, which can correlate the sensor data with the particular region 501, 502, 503, 504 from which the sensor data was collected. The regions 501, 502, 503, 504 can each be different than the other regions.

For example, region 501 can include subregions 505 and 531, with subregion 531 possibly being within the subregion 505. The subregion 531 can be a no-go zone where individuals 4 are prevented from entering. The sensors 72, 74 can monitor if an individual 4 attempts entry into the no-go zone and can send an alert to announce the attempted safety violation. The subregion 505 (which can include the entire region 501), can be a red zone where drop hazards are possible and that individuals 4 (e.g., individual 507) should minimize their time within the red zone 505. This can be seen as the individual 507 entering the red zone 505, performing the needed task, and exiting the red zone 505 after completion of the task to minimize exposure of the individual 507 to the red zone 505. The sensors 72, 74 can detect one or more individuals 4 in the subregion 505 and determine the task(s) performed by the individuals 4 in the subregion 505 and log the tasks.

Region 502 indicates that some of the regions 501, 502, 503, 504 may at times not have an individual 4 within them. The region 502 may, at some point in executing the digital well plan 100 (or digital rig plan 102) may have only rig equipment operating in it. The sensors 72, 74 can be used to detect which of the rig equipment is being operated in the region 502 to perform an actual well activity.

Sensors 72, 74 in regions 503, 504 can detect individuals 4 in each of the regions as well as detecting the rig equipment operating in the regions 503, 504 to perform one or more actual well activities. The sensors 72, 74 in region 503 can identify an individual 509 performing a task in support of an actual well activity while sensors 72, 74 in region 504 can identify an individual 511 (which can be different than the individual 509) performing another task in support of another actual well activity, or possibly in support of the same actual well activity that is being supported by region 503.

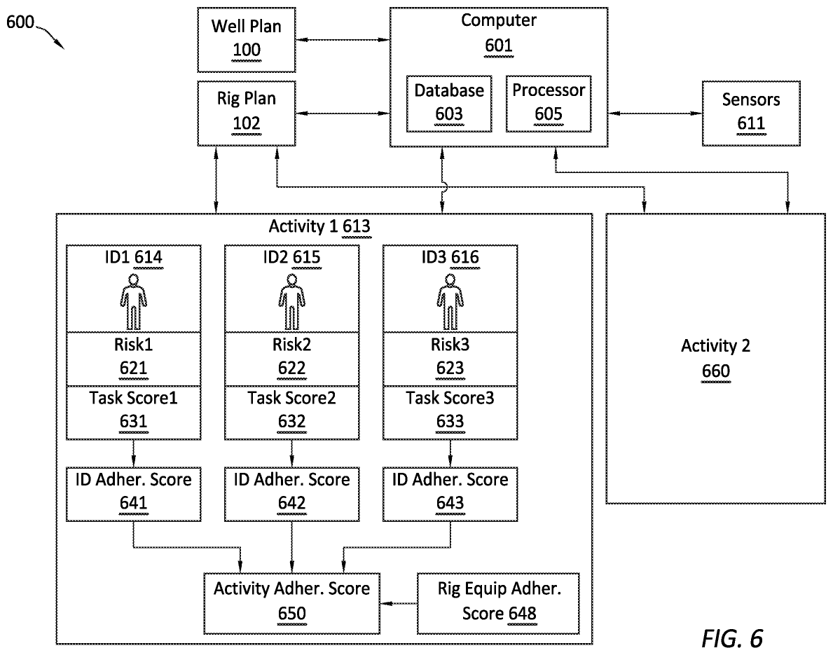

FIG. 6 is a functional block diagram of a method 600 using a computer 601 to determine adherence scores 641, 642, 643, 648, 650 for various individuals, rig equipment, and activities 613, 660. The computer 601, as described in more detail below regarding FIGS. 8A, 8B, 9, can receive a digital well plan 100 and convert the digital well plan 100, via processor(s) 605 and one or more databases 603, into a rig specific digital rig plan 102 for executing the digital well plan 100 on the rig 10. The computer 601 can receive sensor data from sensors 611 (e.g., sensors 72, 74). The rig 10 can begin executing one or more well activities, such as activity 613 and activity 660. These can be serial activities that are executed one after another when the first activity 613 is completed, or they can be parallel activities where at least a portion of the activity 660 is performed simultaneously with the activity 613. As the activity 613 is being executed, the computer 601 can collect sensor data from the sensors 611 and use the sensor data to determine and verify if the actual well activity is the same as the expected activity that should be performed according to the digital well plan 100 (or digital rig plan 102).

The computer 601 can use the sensor data to determine the tasks being performed by the individuals 4 (such as individuals 614, 615, 616) during the activity 613. The computer 601 can compare the sensor data with historical sensor data from a database 603, where the historical sensor data may have been collected from previously executed similar activities on a rig. The comparison can allow the computer 601 to determine the tasks being performed by the individuals 614, 615, 616 and determine a task score 631, 632, 633 for each individual 614, 615, 616 and each task being performed. The task score 631, 632, 633 can indicate the ability of the respective individual 614, 615, 616 to perform the task in acceptable time and quality constraints. If performance expectations are exceeded, then the task score can be higher to indicate a level that expectations are exceeded. If performance expectations are not met, then the task score can be lower to indicate a level that expectations are not met.

The computer 601 can also track the individuals 614, 615, 616 performance (such as task scores 631, 632, 633) over a period of time to develop a respective risk score 621, 622, 623. The computer 601 can then use the task scores 631, 632, 633 and the respective risk scores 621, 622, 623 to determine an adherence score 641, 642, 643 for each respective individual 614, 615, 616. The computer 601 can also use the sensor data from the sensor 611 to determine an adherence score for the rig equipment used during the current well activity 613, 660 to indicate the ability of the rig equipment to meet performance expectations provided in the digital well plan 100 or the database 603. By analyzing the individual adherence scores 641, 642, 643 along with the rig equipment adherence score(s) 648, the computer 601 can determine an overall adherence score 650 of the actual well activity compared to the performance expectations of the digital well plan 100 (or digital rig plan 102) on the rig 10 or the database 603.

This overall activity adherence score 650 can be used to modify the digital well plan 100 for future subterranean operations. The individuals 614, 615, 616 respective risk scores 621, 622, 623 can be used to adapt a scheduled task for any one or more of the individuals 614, 615, 616, such as modify the scheduled task to make the best use of the individuals 614, 615, 616 skills. The individuals 614, 615, 616 respective risk scores 621, 622, 623 can be used to adapt the actual well activity 613 or 660, such as include additional rig equipment not originally in the digital rig plan 102. The individuals 614, 615, 616 respective risk scores 621, 622, 623 can be used to adapt a rig procedure (or digital rig plan) for the rig 10, such as changing a sequence of rig tasks 190 or add one or more individuals 4 to a rig task 190 to decrease rig task duration.

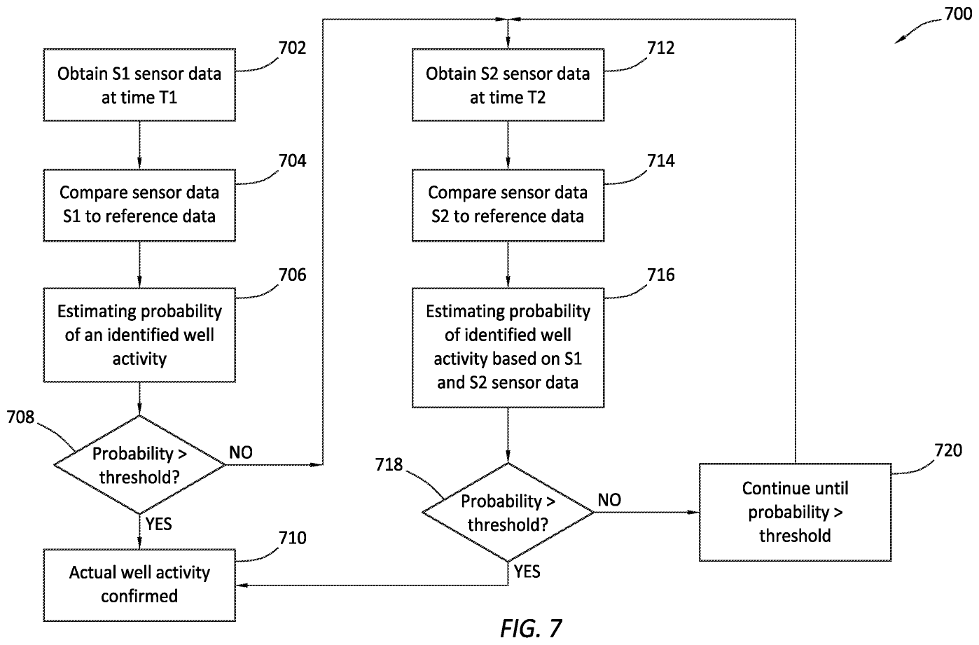

FIG. 7 is a representative flow diagram of a method 700 for determining an actual well activity of a rig 10. In operation 702, the rig controller 250 can collect sensor data S1 from sensors 72, 74 over a first time interval T1. A duration of the first time interval T1 can be adjusted based on an estimated well activity. The sensor data S1 can include imaging data, acoustic data, proximity sensor data, thermal sensor data, vibration sensor data, RFID data, etc. from sensors 72, 74. In operation 704, the rig controller 250 can compare the sensor data S1 to reference data stored in a database (e.g., database 603, 258, etc.). The reference data can include sensor data collected from one or more successfully executed well activities in prior subterranean operations on the same or similar rigs. In operation 706, the rig controller 250 can determine an identified well activity being performed on the rig 10 from the sensor data S1 and estimate a probability (or confidence level) that the identified well activity determined by the rig controller 250 is an actual well activity being performed on the rig 10. In operation 708, rig controller 250 can determine if the probability of the identified well activity being an actual well activity is above or below a threshold value.

If the probability (or confidence level) is greater than the threshold value then the method 700 can proceed to operation 710, where the rig controller 250 can confirm that the identified well activity is the actual well activity being performed on the rig 10. If the probability (or confidence level) is less than the threshold value then the method 700 can proceed to operation 712, where the rig controller 250 can collect sensor data S2 from sensors 72, 74 over a second time interval T2. A duration of the second time interval T2 can be adjusted based on the probability value. A lower probability value can cause the rig controller 250 to extend the second time interval T2, while a higher probability value can cause the rig controller 250 to reduce the second time interval T2. The sensor data S2 can include imaging data, acoustic data, proximity sensor data, thermal sensor data, vibration sensor data, RFID data, etc. (e.g., from sensors 72, 74). In operation 714, the rig controller 250 can compare the sensor data S2 to reference data stored in a database (e.g., database 603, 258, etc.). The reference data can include sensor data collected from one or more successfully executed well activities in prior subterranean operations on the same or similar rigs. In operation 716, the rig controller 250 can determine an identified well activity being performed on the rig 10 based on the sensor data S1 and S2 and estimate a probability that the identified well activity determined by the rig controller 250 is an actual well activity being performed on the rig 10. In operation 718, rig controller 250 can determine if the probability of the identified well activity being an actual well activity is above or below a threshold value. If the probability is greater than the threshold value then the method 700 can proceed to operation 710, where the rig controller 250 can confirm that the identified well activity is the actual well activity being performed on the rig 10. If the probability is less than the threshold value, then the method 700 can proceed back to operation 712 and repeat operations 712 thru 718 until the probability is greater than the threshold value.

FIG. 8A is a representative list of well plan activities 170 for an example digital well plan 100. This list of well plan activities 170 can represent the activities needed to execute a full digital well plan 100. However, in FIG. 8A the list of activities 170 is merely representative of a subset of a complete list of activities needed to execute a full digital well plan 100 to drill and complete a wellbore 15 to a target depth (TD). The digital well plan 100 can include well plan activities 170 with corresponding wellbore depths 172. However, these activities 170 are not required for the digital well plan 100. More or fewer activities 170 can be included in the digital well plan 100 in keeping with the principles of this disclosure. Therefore, the following discussion relating to the well plan activities 170 is merely an example to illustrate the concepts of this disclosure.

After the rig 10 has been utilized to drill the wellbore 15 to a depth of 75, at activity 112, a Prespud meeting can be held to brief all rig personnel on the goals of the digital well plan 100. At activity 114, the appropriate personnel and rig equipment can be used to make-up (M/U) 5½″ drill pipe (DP) stands in prep for the upcoming drilling operation. This can for example require a pipe handler, horizontal or vertical storage areas for tubular segments, or tubular stands.

At activity 118, the appropriate personnel and rig equipment can be used to pick up (P/up), makeup (M/up), and run-in hole (RIH) a BHA with a 36″ drill bit 68. This can, for example, require BHA components; a pipe handler to assist in the assembly of the BHA components; a pipe handler to deliver BHA to a top drive; and lowering the top drive to run the BHA into the wellbore 15.

At activity 120, the appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). At activity 122, the appropriate personnel and rig equipment can be used to pump a high-viscosity pill through the wellbore 15 via the tubular string 58 and then circulate wellbore 15 clean. At activity 124, the appropriate personnel and rig equipment can be used to perform a “wiper trip” by pulling the tubular string 58 out of the hole (Pull out of hole—POOH) to the surface 6; clean stabilizers on the tubular string 58; and run the tubular string 58 back into the hole (Run in hole—RIH) to the bottom of the wellbore 15.

At activities 126 thru 168, the appropriate personnel and rig equipment can be used to perform the indicated well plan activities. Well activities can include the personnel, equipment, or materials needed to directly execute the well plan activities using the specific rig 10, and those activities that ensure the personnel, equipment, or materials are available and configured to support the primary activities.

FIG. 8B is a functional diagram that can illustrate conversion of well plan activities 170 to rig plan tasks 190 of a rig specific digital rig plan 102. When a well plan 100 is designed, well plan activities 170 can be included to describe primary activities needed to construct a desired wellbore 15 to a TD. However, the well plan 100 activities 170 are not specific to a particular rig, such as rig 10. It may not be appropriate to use the well plan activities 170 to direct specific operations on a specific rig, such as rig 10. Therefore, a conversion of the well plan activities 170 can be performed to create a list of rig plan tasks 190 of a digital rig plan 102 to construct the desired wellbore 15 using a specific rig, such as rig 10. This conversion engine 180 (which can run on a computing system such as the rig controller 250) can take the non-rig specific well plan activities 170 as an input and convert each of the non-rig specific well plan activities 170 to one or more rig specific tasks 190 to create a digital rig plan 102 that can be used to direct tasks on a specific rig, such as rig 10, to construct the desired wellbore 15.

As way of example, a high-level description of the conversion engine 180 will be described for a subset of well plan activities 170 to demonstrate a conversion process to create the digital rig plan 102. The well plan activity 118 states, in abbreviated form, to pick up, make up, and run-in hole a BHA 60 with a 36″ drill bit. The conversion engine 180 can convert this single non-rig specific activity 118 into, for example, three rig-specific tasks 118.1, 118.2, 118.3. Task 118.1 can instruct the rig operators or rig controller 250 to pickup the BHA 60 (which has been outfitted with a 36″ drill bit) with a pipe handler. At task 118.2, the pipe handler can carry the BHA 60 and deliver it to the top drive 18, with the top drive 18 using an elevator to grasp and lift the BHA 60 into a vertical position. At task 118.3, the top drive 18 can lower the BHA 60 into the wellbore 15 which has already been drilled to a depth of 75′ for this example as seen in FIG. 8A. The top drive 18 can lower the BHA 60 to the bottom of the wellbore 15 to have the drill bit 68 in position to begin drilling as indicated in the following well activity 120.

The well plan activity 120 states, in abbreviated form, to drill a 36″ hole to a target depth (TD) of the section, such as 652 ft, to +/−30 ft inside a known formation layer (e.g., Dammam), and performing a deviation survey at depths of 150′, 500′ and TD (i.e., 652′ in this example). The conversion engine 180 can convert this single non-rig specific activity 120 into, for example, seven rig-specific tasks 120.1 to 120.7. Task 120.1 can instruct the rig operators or rig controller 250 to circulate mud through the top drive 18, through the drill string 58, through the BHA 60, and exiting the drill string 58 through the drill bit 68 into the annulus 17. For this example, the mud flow requires two mud pumps 84 to operate at “NN” strokes per minute, where “NN” is a desired value that delivers the desired mud flow and pressure. At task 120.2, the shaker tables can be turned on in preparation for cuttings that should be coming out of the annulus 17 when the drilling begins. At task 120.3, a mud engineer can verify that the mud characteristics are appropriate for the current tasks of drilling the wellbore 15. If the rheology indicates that mud characteristics should be adjusted, then additives can be added to adjust the mud characteristics as needed.

At task 120.4, rotary drilling can begin by lowering the drill bit into contact with the bottom of the wellbore 15 and rotating the drill bit by rotating the top drive 18 (e.g., rotary drilling). The drilling parameters can be set to be “XX” ft/min for rate of penetration (ROP), “YY” lbs for weight on bit (WOB), and “ZZ” revolutions per minute (RPM) of the drill bit 68.

At task 120.5, as the wellbore 15 is extended by the rotary drilling when the top end of the tubular string 58 is less than “XX” ft above the rig floor 16, then a new tubular segment (e.g. tubular, tubular stand, etc.) can be added to the tubular string 58 by retrieving a tubular segment 50, 54 from tubular storage via a pipe handler, stop mud flow and disconnect the top drive from the tubular string 58, hold the tubular string 58 in place via the slips at well center, raise the top drive 18 to provide clearance for the tubular segment to be added, transfer tubular segment 50, 54 from the pipe handler 30 to the top drive 18, connect the tubular segment 50, 54 to the top drive 18, lower the tubular segment 50, 54 to the stump of the tubular string 58 and connect it to the tubular string 58 using a roughneck to torque the connection, then start mud flow. This can be performed each time the top end of the tubular string 58 is lowered below “XX” ft above the rig floor 16.

At task 120.6, add tubular segments 50, 54 to the tubular string 58 as needed in task 120.5 to drill wellbore 15 to a depth of 150 ft. Stop rotation of the drill bit 68 and stop mud pumps 84.

At task 120.7, perform a deviation survey by reading the inclination data from the BHA 60, comparing the inclination data to expected inclination data, and report deviations from the expected. Correct drilling parameters if deviations greater than a pre-determined limit.

The conversion from a well plan 100 to a rig-specific rig plan 102 can be performed manually or automatically with the best practices and equipment recipes known for the rig that is to be used in the wellbore construction.

FIG. 9 is a representative functional block diagram of the rig plan engine 180 that can include possible databases used by a rig controller 250 to convert a digital well plan 100 to a digital rig plan 102 and for identifying individuals detected in work zones on the rig 10. The rig plan engine 180 can be a program (i.e., list of instructions 268) that can be stored in the non-transitory memory 252 and executed by processor(s) 254 of the rig controller 250 to convert a digital well plan 100 to a digital rig plan 102 or identify individuals 4 on the rig 10.

A digital well plan 100 can be received at an input to the rig controller 250 via a network interface 256. The digital well plan 100 can be received by the processor(s) 254 and stored in the memory 252. The processor(s) 254 can then begin reading the sequential list of well plan activities 170 of the digital well plan 100 from the memory 252. The processor(s) 254 can process each well plan activity 170 to create rig-specific tasks to implement the respective activity 170 on a specific rig (e.g., rig 10).

To convert each well plan activity 170 to rig-specific tasks for a rig 10, processor(s) 254 must determine the equipment available on the rig 10, the best practices, operations, and parameters for running each piece of equipment, and the operations to be run on the rig to implement each of the well plan activities 170.

Referring again to FIG. 9, the processor(s) 254 are communicatively coupled to the non-transitory memory 252 which can store multiple databases for converting the well plan 100 into the rig plan 102 or for identifying individuals detected in work zones on the rig 10. A rig operations database 260 includes rig operations for implementing each of the well plan activities 170. Each of the rig operations can include one or more tasks to perform the rig operation. The processor(s) 254 can retrieve those operations for implementing the first rig activity 170 from the rig operations database 260 including the task lists for each operation. The processor(s) 254 can receive a rig type RT from a user input or the network interface 256. With the rig type RT, the processor(s) 254 can retrieve a list of equipment available on the rig 10 from the rig type database 262, which can contain equipment lists for a plurality of rig types.

The processor(s) 254 can then convert the operation tasks to rig specific tasks to implement the operations on the rig 10. The rig specific tasks can include the appropriate equipment for rig 10 to perform the operation task. The processor(s) 254 can then collect the recipes for operating each of the available equipment for rig 10 from the recipes database 266, where the recipes can include best practices on operating the equipment, preferred parameters for operating the equipment, and operational tasks for the equipment (such as turn ON procedures, ramp up procedures, ramp down procedures, shutdown procedures, etc.).

Therefore, the processor(s) 254 can retrieve each of the well plan activities 170 and convert them to a list of rig specific tasks that can perform the respective well plan activity 170 on the rig 10. After converting all of the well plan activities 170 to rig specific tasks 190 and creating a sequential list of the tasks 190, the processor(s) 254 can store the resulting digital rig plan 102 in the memory 252. When the rig 10 is operational and positioned at the proper location to drill a wellbore 15, the rig controller 250, via the processor(s) 254, can begin executing the list of tasks in the digital rig plan 102 by sending control signals and messages to the equipment control 270.

The rig controller 250 can also receive user input from an input device 272 or display information to a user or individual 4 via a display 274. The input device 272 in cooperation with the display 274 can be used to input well plan activities, initiate processes (such as converting the digital well plan 100 to the digital rig plan 102), select alternative activities, or rig tasks during execution of digital well plan 100 or digital rig plan 102, or monitor operations during well plan execution. The input device 272 can also include the sensors 74 and the imaging sensors 72, which can provide sensor data (e.g., image data, temperature sensor data, pressure sensor data, operational parameter sensor data, etc.) to the rig controller 250 for determining the actual well activity of the rig.

### VARIOUS EMBODIMENTS

Embodiment 1. A method for analyzing an environment comprising:

conducting a subterranean operation within an environment;

obtaining sensor data from one or more sensors configured to monitor the environment;

identifying an actual well activity within the environment based on the sensor data;

identifying an individual within the environment based on the sensor data; and

calculating an adherence score for the actual well activity based at least in part on an adherence score of the individual performing a task in the environment.

Embodiment 2. The method of embodiment 1, wherein the environment includes at least part of a rig performing the subterranean operation.

Embodiment 3. The method of embodiment 1, wherein the actual well activity is conducted by one or more machines configured to conduct a subterranean operation and one or more individuals performing tasks during the subterranean operation.

Embodiment 4. The method of embodiment 1, wherein the one or more sensors includes an imaging sensor, acoustic sensor, proximity sensor, thermal sensor, vibration sensor, or any combination thereof.

Embodiment 5. The method of embodiment 1, wherein the one or more sensors are remote from the individual.

Embodiment 6. The method of embodiment 1, wherein the one or more sensors are on the individual and include one or more electronic devices with wireless communication capabilities.

Embodiment 7. The method of embodiment 1, wherein the sensor data includes imaging data, acoustic data, proximity data, thermal data, vibration data, or any combination thereof.

Embodiment 8. The method of embodiment 1, wherein identifying the actual well activity within the environment comprises comparing the sensor data to a database including reference data for computing the actual well activity within the environment.

Embodiment 9. The method of embodiment 8, wherein reference data includes historical data associated with previously completed actual well activities, and wherein identifying the actual well activity includes comparing sensor data to historical data to identify the actual well activity.

Embodiment 10. The method of embodiment 8, wherein reference data includes a list of rig procedures and associated sensor data that occurs for each of the rig procedures, and wherein identifying an actual well activity within the environment includes comparing the sensor data to the list of rig procedures and associated sensor data.

Embodiment 11. The method of embodiment 1, wherein identifying an actual well activity within the environment includes confirming the actual well activity of the environment using sensor data.

Embodiment 12. The method of embodiment 11, wherein confirming the actual well activity includes obtaining sensor data for a first time interval, obtaining sensor data for a second time interval after the first time interval, comparing the sensor data of the first time interval and second time interval to confirm the actual well activity.

Embodiment 13. The method of embodiment 12, wherein a duration of the second time interval may be based upon a duration of the first time interval.

Embodiment 14. The method of embodiment 12, wherein a duration of the first time interval may be based upon an estimated well activity.

Embodiment 15. The method of embodiment 11, wherein confirming the actual well activity comprises:

obtaining sensor data for a first time interval;

comparing the sensor data of the first time interval to reference data from a database to identify an estimated well activity within the environment;

obtaining sensor data for a second time interval after the first time interval; and

comparing the sensor data for second time interval to the estimated well activity to confirm the actual well activity.

Embodiment 16. The method of embodiment 15, wherein a duration of the second time interval is based on a confidence level in the estimated well activity.

Embodiment 17. The method of embodiment 1, wherein obtaining sensor data includes selecting one or more types of different sensor data based upon an expected activity within the environment.

Embodiment 18. The method of embodiment 1, wherein obtaining sensor data includes estimating a confidence level of an actual well activity within the environment based upon the sensor data and obtaining subsequent data based upon the confidence level of the actual well activity.

Embodiment 19. The method of embodiment 1, wherein identifying an individual within the environment includes identifying the individual based on a detected identification number within the environment.

Embodiment 20. The method of embodiment 1, wherein identifying an individual within the environment includes identifying the individual based on a detected physical parameter within the environment.

Embodiment 21. The method of embodiment 20, wherein identifying an individual includes detecting an individual using a sensor that is remote from the individual being detected.

Embodiment 22. The method of embodiment 21, wherein the sensor is configured to communicate with at least one electronic device worn by a user.

Embodiment 23. The method of embodiment 1, wherein identifying an individual comprises:

sensing an individual using one or more sensors remote from the individual;

sending a communication from the one or more sensors to a wearable electronic device on the individual; and

confirming an identity of the individual by exchange of information between the one or more sensors and the wearable electronic device on the individual.

Embodiment 24. The method of embodiment 20, wherein identifying an individual within the environment includes detecting a characteristic within the environment, associating the characteristic with the individual using a database to identify the individual within the environment.

Embodiment 25. The method of embodiment 24, wherein the characteristic is a unique shape aspect of the individual based on at least one of a silhouette, size, walking stride, posture, body movements, acoustic signals, facial features, and combinations thereof.

Embodiment 26. The method of embodiment 1, wherein identifying an individual within the environment includes detecting the individual using an imaging sensor.

Embodiment 27. The method of embodiment 1, wherein identifying an individual within the environment includes using an imaging sensor to detect a plurality of individuals and comparing the sensor data for each individual to unique physical parameter data associated with each individual to differentiate and identify each individual of the plurality of individuals.

Embodiment 28. The method of embodiment 1, further comprising tracking an individual within the environment.

Embodiment 29. The method of embodiment 1, further comprising scoring an individual's task within the environment.

Embodiment 30. The method of embodiment 29, further comprising adapting a rig procedure based on an individual's task.

Embodiment 31. The method of embodiment 29, further comprising adapting the activity based on the individual's task.

Embodiment 32. The method of embodiment 29, wherein scoring an individual's task comprises:

tracking an actual task of the individual within the environment for a duration of time;

comparing the actual task of the individual to a database of expected tasks to be completed by the individual within the environment;

identifying any deviations of the actual task from the expected tasks; and

scoring the actual task based on any deviations.

Embodiment 33. The method of embodiment 32, wherein the expected tasks of the individual are selected from a database based on a rig plan.

Embodiment 34. The method of embodiment 32, wherein the expected tasks of the individual are based on rig procedures occurring within the environment.

Embodiment 35. The method of embodiment 32, wherein the expected tasks of the individual are selected from a database including an individual's scheduled tasks.

Embodiment 36. The method of embodiment 32, further comprising adapting a rig procedure based on scoring of the actual task of the individual.

Embodiment 37. The method of embodiment 32, further comprising adapting the activity based on the scoring of the actual task of the individual.

Embodiment 38. The method of embodiment 1, further comprising calculating a risk score for an individual.

Embodiment 39. The method of embodiment 38, wherein a risk score is calculated from a plurality of task scores for an individual.

Embodiment 40. The method of embodiment 38, further comprising adapting an individual's scheduled task based on their risk score.

Embodiment 41. The method of embodiment 38, further comprising adapting a rig procedure based on risk scores for one or more individuals.

Embodiment 42. The method of embodiment 38, further comprising adapting the actual well activity based on risk scores for one or more individuals.

Embodiment 43. The method of embodiment 38, wherein calculating a risk score for an individual further includes weighting factors selected from the group of at least an experience of the individual, a proficiency score, familiarity with rig equipment, familiarity with a rig procedure, familiarity with the activity, environmental conditions, actual or perceived injuries, hours active, or any combination thereof.

Embodiment 44. The method of embodiment 38, further comprising storing risk data of one or more individuals and evaluating a change in risk score of one or more individuals over time.

Embodiment 45. The method of embodiment 38, further comprising storing risk data of one or more individuals and evaluating a change in risk score of one or more individuals associated with the actual well activity.

Embodiment 46. The method of embodiment 38, further comprising storing risk data of one or more individuals and evaluating a change in risk score of one or more individuals associated with a rig operation.

Embodiment 47. The method of embodiment 38, further comprising storing risk data for a group of individuals and evaluating a change in risk score of the group of individuals over time.

Embodiment 48. The method of embodiment 38, further comprising storing risk data for a group of individuals and evaluating a change in risk score of the group of individuals associated with a given task.

Embodiment 49. The method of embodiment 38, further comprising storing risk data for a group of individuals and evaluating a change in risk score of the group of individuals associated with a given rig operation.

Embodiment 50. The method of embodiment 38, further using risk data for an individual or group of individuals to develop a new rig plan.

Embodiment 51. The method of embodiment 1, wherein:

obtaining sensor data from one or more sensors configured to monitor the environment includes obtaining sensor data for a first portion of the environment;

identifying one or more personnel support activities configured to support completion of the actual well activity;

identifying one or more individuals within the environment configured to be conducting one or more personnel support tasks;

calculating a task score for one or more individuals, wherein the task score is calculated based in part upon completeness of the personnel support tasks of the one or more individuals; and calculating the adherence score based at least in part on the task score.

Embodiment 52. The method of embodiment 1, wherein obtaining the sensor data to identify an actual well activity is conducted within a first region of the environment and identifying an individual within the environment includes identifying an individual in a second region of the environment, wherein the first region and second region are different regions.

Embodiment 53. The method of embodiment 1, wherein obtaining sensor data to identify an actual well activity is conducted with a first sensor, and identifying an individual within the environment is conducted with a second sensor, wherein the first sensor and second sensor are different sensors.

Embodiment 54. The method of embodiment 1, further comprising notifying one or more individuals of their task score.

Embodiment 55. The method of embodiment 1, further comprising notifying one or more individuals of a task score.

Embodiment 56. A system configured to carry out any of the methods claimed herein.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1. A method for analyzing an environment comprising:
conducting a subterranean operation within an environment;
obtaining sensor data from one or more sensors configured to monitor the environment;
identifying, via a rig controller, an actual well activity within the environment based on the sensor data;
identifying, via the rig controller, an individual within the environment based on the sensor data; and
calculating, via the rig controller, an adherence score for the actual well activity based at least in part on an adherence score of the individual performing a task in the environment.

2. The method of claim 1, wherein the actual well activity is conducted by one or more pieces of rig equipment configured to conduct a subterranean operation and one or more individuals performing tasks during the subterranean operation.

3. The method of claim 1, wherein identifying the actual well activity within the environment comprises comparing the sensor data to a database including reference data for computing the actual well activity within the environment.

4. The method of claim 3, wherein reference data includes historical data associated with previously completed actual well activities, and wherein identifying the actual well activity includes comparing sensor data to the historical data to identify the actual well activity.

5. The method of claim 3, wherein reference data includes a list of rig procedures and associated sensor data that occurs for each of the rig procedures, and wherein identifying the actual well activity within the environment includes comparing the sensor data to the list of rig procedures and associated sensor data.

6. The method of claim 1, wherein identifying an actual well activity within the environment includes confirming the actual well activity of the environment using sensor data.

7. The method of claim 6, wherein confirming the actual well activity comprises:
obtaining sensor data for a first time interval;
comparing the sensor data of the first time interval to reference data from a database to identify an estimated well activity within the environment;
obtaining sensor data for a second time interval after the first time interval; and
comparing the sensor data for second time interval to the estimated well activity to confirm the actual well activity.

8. The method of claim 7, wherein a duration of the second time interval is based on a confidence level in the estimated well activity.

9. The method of claim 1, wherein obtaining sensor data includes estimating a confidence level of an actual well activity within the environment based upon the sensor data and obtaining subsequent data based upon the confidence level of the actual well activity.

10. The method of claim 1, wherein identifying the individual comprises:
sensing an individual using one or more sensors remote from the individual;
sending a communication from the one or more sensors to a wearable electronic device on the individual; and
confirming an identity of the individual by exchange of information between the one or more sensors and the wearable electronic device on the individual.

11. The method of claim 10, wherein identifying the individual within the environment includes detecting a characteristic within the environment, associating the characteristic with the individual using a database to identify the individual within the environment.

12. The method of claim 11, wherein the characteristic is a unique shape aspect of the individual based on at least one of a silhouette, size, walking stride, posture, body movements, acoustic signals, facial features, and combinations thereof.

13. The method of claim 1, wherein identifying the individual within the environment includes using an imaging sensor to detect a plurality of individuals and comparing the sensor data for each of the plurality of individuals to unique physical parameter data associated with each of the plurality of individuals to differentiate and identify each individual of the plurality of individuals.

14. The method of claim 1, further comprising scoring an individual's task within the environment.

15. The method of claim 14, wherein scoring an individual's task comprises:
tracking an actual task of the individual within the environment for a duration of time;
comparing the actual task of the individual to a database of expected tasks to be completed by the individual within the environment;
identifying any deviations of the actual task from the expected tasks; and
scoring the actual task based on any deviations.

16. The method of claim 1, further comprising calculating, via the rig controller, a risk score for an individual.

17. The method of claim 16, further comprising:
adapting, via the rig controller, an individual's scheduled task based on their risk score;
or adapting, via the rig controller, a rig procedure based on risk scores for one or more individuals; or adapting, via the rig controller, the actual well activity based on risk scores for one or more individuals; or
combinations thereof.

18. The method of claim 16, wherein calculating a risk score for an individual further includes weighting factors selected from the group of at least an experience of the individual, a proficiency score, familiarity with rig equipment, familiarity with a rig procedure, familiarity with the activity, environmental conditions, actual or perceived injuries, hours active, or any combination thereof.

19. The method of claim 16, further comprising storing risk data for a group of individuals and evaluating a change in risk score of the group of individuals associated with a given task or rig operation.

20. The method of claim 16, further using risk data for an individual or group of individuals to develop a new rig plan.
